(19) United States
(12) Patent Application Publication
(10) Pub. No.: US 2012/0154871 A1
(43) Pub. Date: Jun. 21, 2012

(54) PRINTING APPARATUS, PRINTING APPARATUS CONTROL METHOD, AND STORAGE MEDIUM

(75) Inventor: Yoshitaka Oba, Kawasaki-shi (JP)

(73) Assignee: CANON KABUSHIKI KAISHA, Tokyo (JP)

(21) Appl. No.: 13/304,122

(22) Filed: Nov. 23, 2011

(30) Foreign Application Priority Data
Dec. 15, 2010 (JP) 2010-279669

(51) Int. Cl. G06K 15/00

(52) U.S. Cl. 358/1.18

(57) ABSTRACT

A printing apparatus to print an image on both surfaces of a tab sheet includes a setting unit and a printing unit. The setting unit sets whether to align an orientation of a first image to be printed on a first surface tab portion of a first surface of the tab sheet with an orientation of a second image to be printed on a second surface tab portion of a second surface of the tab sheet. In response to the setting unit setting to align the first and second image orientations, the printing unit prints the first and second image to equalize the orientation of the first and second image. In response to the setting unit setting not to align the first and second image orientation, the printing unit prints the first and second image to differentiate the orientation of the first and second image.

### BACKGROUND OF THE INVENTION

1. Field of the Invention

The present invention relates to a printing apparatus, a printing apparatus control method, and a storage medium.

2. Description of the Related Art

The business flow of conventional print industries includes, as fundamental phases, receiving an order from a customer (or a client), producing printed products (e.g., magazines, newspapers, catalogs, advertisement prints, gravures, etc.) according to the order, and delivering the finished products to the customer (or client).

Many of conventional printing companies are still using large-scale printing apparatuses, such as offset-type printing machines. The printing work according to a conventional printing method includes various processes, such as document reception, design, layout, comprehensive layout (presentation based on a printer output), correction (layout correction or color correction), proof (proof print), block copy preparation, printing, post-processing treatment, and delivery.

The preparation of a block copy is a mandatory process. When a block copy is once finished, modifying or correcting the block copy is not easy. Complicated correction, if performed at later timing, increases the total manufacturing cost. Accordingly, the printing work according to the conventional printing method requires careful corrections, including check of the layout and confirmation of colors. In this manner, the conventional printing method requires a large-scale device and a sufficiently longer time to finish the print works as requested by a customer or client.

On the other hand, electrophotographic printing apparatuses and inkjet printing apparatuses can realize high-speed and high-quality print outputs. A new business model “Print on Demand (referred to POD)” has been recently introduced to develop a new market of electronic data-based digital printing.

The POD system has the capability of processing a relatively small lot of job and finishing the job in a short time period without using a large-scale device or system. To this end, instead of using the conventional commercial printing technique, the electronic data-based digital printing has been used frequently. Under such circumstances, printers and digital copying machines are required to have functions comparable to those that are usable in the conventional commercial printing industry.

As discussed in Japanese Patent Application Laid-Open No. 2004-058508, there is a conventional printing apparatus (and a related method) capable of detecting the orientation of a sheet having a heading portion, which is generally referred to as a “tab sheet”, and rotating an image to be printed so that the image can be accurately positioned on the heading portion.

However, according to the technique discussed in the above-described Japanese Patent Application Laid-Open No. 2004-058508, the rotation of each image is uniform to have a predetermined relationship with the conveyance direction of a bundle of tab sheets. Therefore, the conventional printing apparatus may output a printed product that is not intended by a user.

In particular, when the printing apparatus produces a booklet (or a pamphlet) that includes at least one tab sheet to be placed in a drawer, the heading portion of each tab sheet is required to face toward the outer side (i.e., the front edge direction) on each of the front/back surfaces. To generate heading portions of tab sheets differently for the front/back surfaces, the printing apparatus is required to generate each document considering the orientation of an output product. As a result, the generation of each document becomes very complicated.

### SUMMARY OF THE INVENTION

According to an aspect of the present invention, a printing apparatus to print an image on both surfaces of a tab sheet includes a setting unit configured to set whether to align an orientation of a first image to be printed on a first surface tab portion of a first surface of the tab sheet with an orientation of a second image to be printed on a second surface tab portion of a second surface of the tab sheet, and a printing unit configured to, in response to the setting unit setting to align the orientation of the first image with the orientation of the second image, print the first image on the first surface tab portion and the second image on the second surface tab portion in such a way as to equalize the orientation of the first image with the orientation of the second image, and configured to, in response to the setting unit setting not to align the orientation of the first image with the orientation of the second image, print the first image on the first surface tab portion and the second image on the second surface tab portion in such a way as to differentiate the orientation of the first image from the orientation of the second image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a printing system including an image forming apparatus according to an example embodiment.

FIG. 2 is a block diagram illustrating an example configuration of a print environment illustrated in FIG. 1.

FIG. 3 illustrates a user interface (UI) that can be displayed by a client personal computer (PC) according to an example embodiment.

FIGS. 4A and 4B illustrate tab sheet image generation processing that can be applied to the image forming apparatus according to an example embodiment.

FIG. 5 is a flowchart illustrating a control procedure for controlling the image forming apparatus according to an exemplary embodiment.

FIGS. 6A and 6B are flowcharts illustrating control procedures for controlling the image forming apparatus according to an exemplary embodiment.

FIG. 7 illustrates an original document in comparison with an output result of printed tab sheets.

FIG. 8 illustrates an example UI that can be displayed by a client PC according to an example embodiment.

FIGS. 9A and 9B illustrate example calculations for obtaining the drawing position of a tab sheet heading image according to an exemplary embodiment.

FIG. 10 is a flowchart illustrating a control procedure for controlling the image forming apparatus according to an exemplary embodiment.

FIGS. 11A and 11B are flowcharts illustrating control procedures for controlling the image forming apparatus according to an exemplary embodiment.

FIG. 12 illustrates an original document in comparison with an output result of printed tab sheets.

FIG. 13 illustrates an original document in comparison with an output result of printed tab sheets.

FIG. 14 illustrates an example UI that can be displayed by a client PC according to an example embodiment.

FIGS. 15A, 15B, 15C, and 15D illustrate example calculations for obtaining the drawing position of a tab sheet heading image according to an exemplary embodiment.

FIG. 16 is a flowchart illustrating a control procedure for controlling the image forming apparatus according to an exemplary embodiment.

FIGS. 17A and 17B are flowcharts illustrating control procedures for controlling the image forming apparatus according to an exemplary embodiment.

FIG. 18 illustrates an original document in comparison with an output result of printed tab sheets.

FIG. 19 illustrates an original document in comparison with an output result of printed tab sheets.

### DESCRIPTION OF THE EMBODIMENTS

Various exemplary embodiments, features, and aspects of the invention will be described in detail below with reference to the drawings.

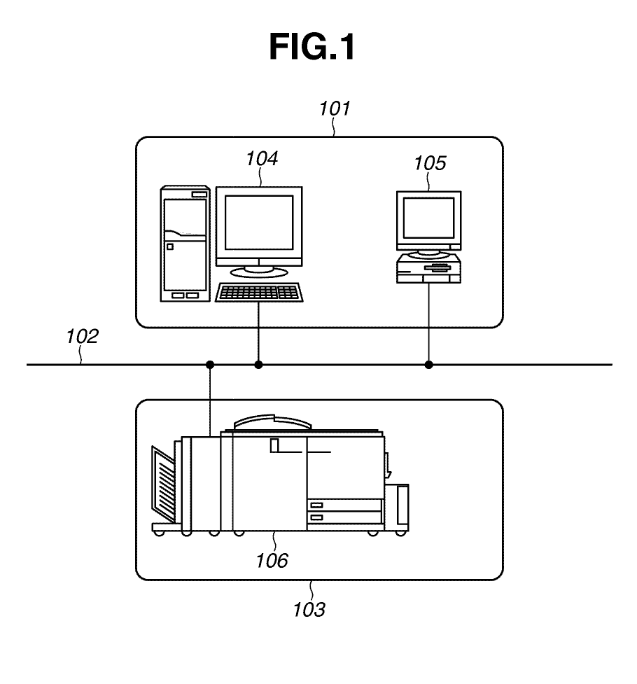

FIG. 1 illustrates an example of a printing system including an image forming apparatus (e.g., a printing apparatus) according to a first exemplary embodiment. The printing system according to the present exemplary embodiment includes at least one end user environment 101 and a print environment 103, which are mutually connected via a network 102.

As illustrated in FIG. 1, the end user environment 101 according to the present exemplary embodiment includes an end user environment 104 and another end user environment 105. Each of the end user environment 104 and the end user environment 105 can be constituted by a client PC. The print environment 103 can be constituted by an image forming apparatus 106 that includes a document reading apparatus.

Further, each of the end user environment 104 and the end user environment 105 can be used for a user to generate and output document data, to confirm an output status of the document data, and to correct the document data.

On the other hand, the image forming apparatus 106 can receive a paper document read by the document reading apparatus as document/image data and also can receive document data if it is generated by the end user environment 101. The image forming apparatus 106 can perform various processing (including image correction, file merging, page insertion/deletion, page layout editing, and imposition) on stored document data when it is output from the image forming apparatus 106.

Further, when the document data is output, the image forming apparatus 106 can perform finishing processing (e.g., paper folding, saddle stitch binding, case bookbinding, cutting, insertion, and collation) on an output recording medium according to a work instruction included in a print job.

A print product can be output when document data generated by a user is input to the printing system including the end user environment 101 and the image forming apparatus 106 including the document reading apparatus.

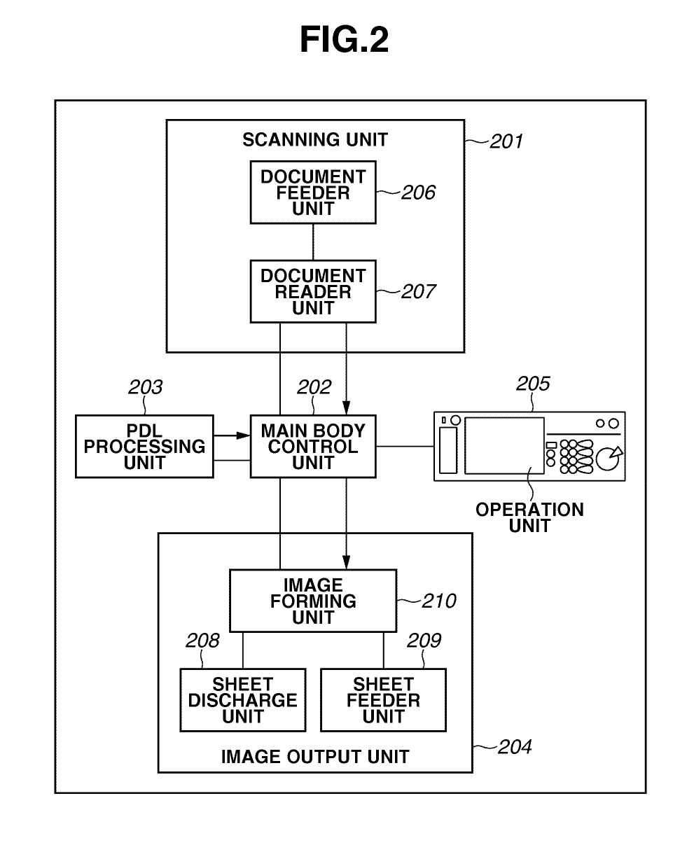

FIG. 2 is a block diagram illustrating an example configuration of the print environment 103 illustrated in FIG. 1.

In FIG. 2, the print environment 103 includes a scanning unit 201, a main body control unit 202, a page description language (PDL) processing unit 203, an image output unit 204, and an operation unit 205. Further, the scanning unit 201 includes a document feeder unit 206 and a document reader unit 207. The image output unit 204 includes a sheet discharge unit 208, a sheet feeder unit 209, and an image forming unit 210.

When a user places and sets a document on the document feeder unit 206, the scanning unit 201 causes the document reader unit 207 to read the document according to a copy/image formation instruction input via the operation unit 205.

The main body control unit 202 can perform control for driving the scanning unit 201 and the image output unit 204. Further, the main body control unit 202 can perform control for a program to be executed in each of various modes described below. When the PDL processing unit 203 receives page description language (i.e., PDL) data generated by the end user environment 101, the PDL processing unit 203 generates print data based on the received PDL data.

When the image output unit 204 outputs document/image data read by the scanning unit 201 or print data generated by the PDL processing unit 203, the image output unit 204 can perform image correction processing, file merging and page insertion/deletion processing, and required imposition processing according to a work instruction contained in the data.

The image output unit 204 causes the sheet discharge unit 208 and the sheet feeder unit 209 to output the data on a recording medium. At the same time, the image output unit 204 performs finishing processing (e.g., paper folding, saddle stitch binding, case bookbinding, cutting, insertion, and collation) on the recording medium according to the work instruction.

The operation unit 205 can be used to operate the image forming apparatus 106 according to the present exemplary embodiment. The operation unit 205 can transmit key information input via the operation unit 205 to the main body control unit 202. The image forming apparatus 106 can control various operations to be realized by the printing system.

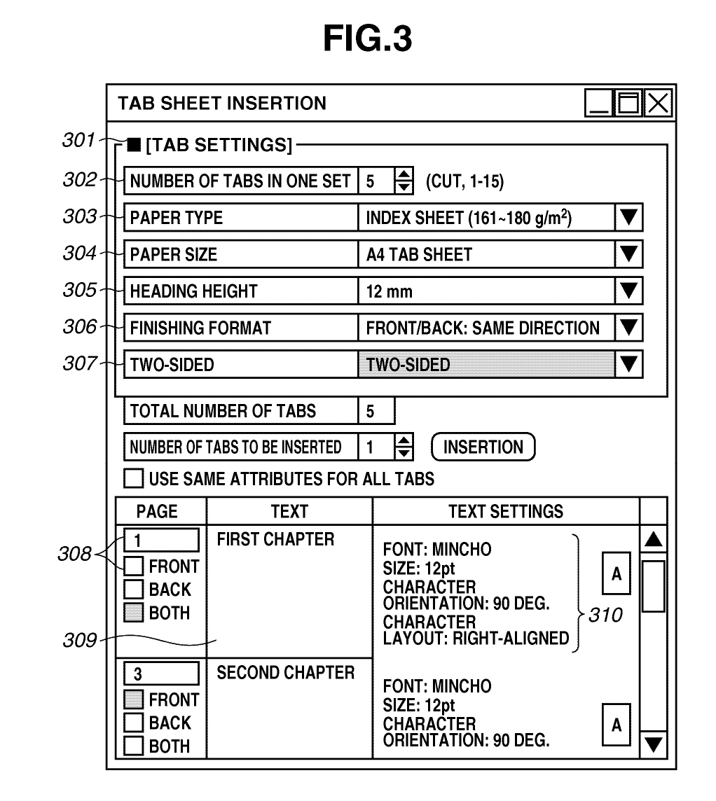

FIG. 3 illustrates an example of a user interface that can be displayed by a display apparatus included in the end user environment 105 illustrated in FIG. 1. Hereinafter, an example setting of each parameter that can be performed by the end user environment 101 for tab sheet insertion printing is described in detail below with reference to FIG. 3.

In the context of the present disclosure, the terminology “parameter” indicates information usable to identify characteristics of a tab sheet to be inserted into an original document. For example, the “parameter” can include a plurality of setting parameters. In the following description, parameters may be simply referred to as “settings.” In the present exemplary embodiment, the original document does not include any tab sheet document.

A setting screen 301 illustrated in FIG. 3 includes various input fields that enable users to set parameters for a tab sheet to be used in the printing. More specifically, the setting screen 301 includes a setting field 302 in which the number of headings can be designated, a setting field 303 in which the type of the insertion paper can be designated, and a setting field 304 in which the size of the insertion paper can be designated.

Further, the setting screen 301 includes a setting field 305 in which the heading height of the tab sheet can be designated, a setting field 306 in which the finishing format can be designated, and a setting field 307 in which the surface to be printed can be designated.

Further, the setting screen 301 includes an additional input field that enables users to set parameters relating to a heading portion of the tab sheet. More specifically, the setting screen 301 includes a setting field 308 in which the insertion position can be designated, an input field 309 in which a text to be printed can be designated, and a setting field 310 in which detailed settings for the text can be performed.

In the present exemplary embodiment, the number of headings setting field 302, the insertion paper type setting field 303, the insertion paper size setting field 304, the heading height setting field 305, and the finishing format setting field 306 can be used for detailed settings of the tab sheet to be printed. The finishing format setting field 306 enables users to select either “same direction” or “different directions” with respect to the front/back surfaces.

In the end user environment 104 or the end user environment 105, if a setting fixing button is pressed, print setting information having been designated in respective items of the setting screen 301 illustrated in FIG. 3 can be converted into print data and transmitted to the image forming apparatus 106.

In the present exemplary embodiment and other exemplary embodiments, the paper size of a tab sheet can be identical to or greater than a document size having been set in a print job as part of document information.

Further, in the present exemplary embodiment and other exemplary embodiments, the print job received from an end user environment includes a tab sheet document. The tab sheet document can be a two-sided tab sheet document or a one-sided tab sheet document.

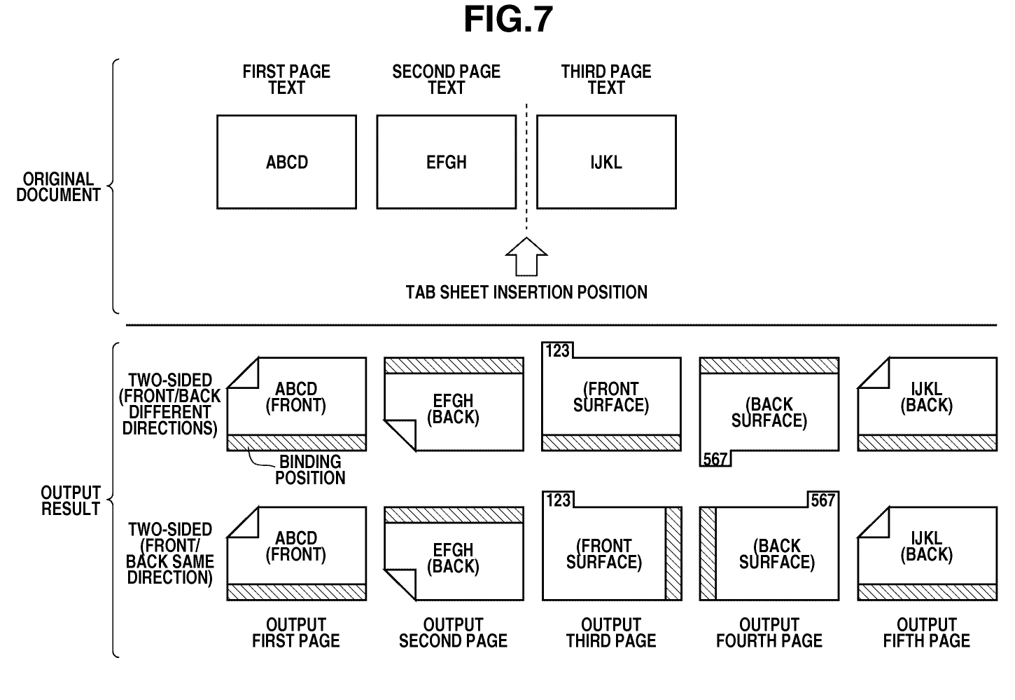

When a tab sheet heading image is drawn by the main body control unit 202 according to tab insertion information having been set for an original document illustrated in FIG. 7, the drawing position of the image can be calculated in the following manner.

When the image forming apparatus 106 outputs a printed product according to a print job that includes a tab sheet to be added to a text document (i.e., an original document) generated by a user, the image forming apparatus 106 generates a tab sheet document according to detailed tab sheet settings having been set by the user using the UI illustrated in FIG. 3 and inserts a tab sheet at a predetermined position. Hereinafter, an example method for controlling the image forming apparatus 106 to generate a tab sheet document, insert the generated document at a predetermined position, and print the document is described below.

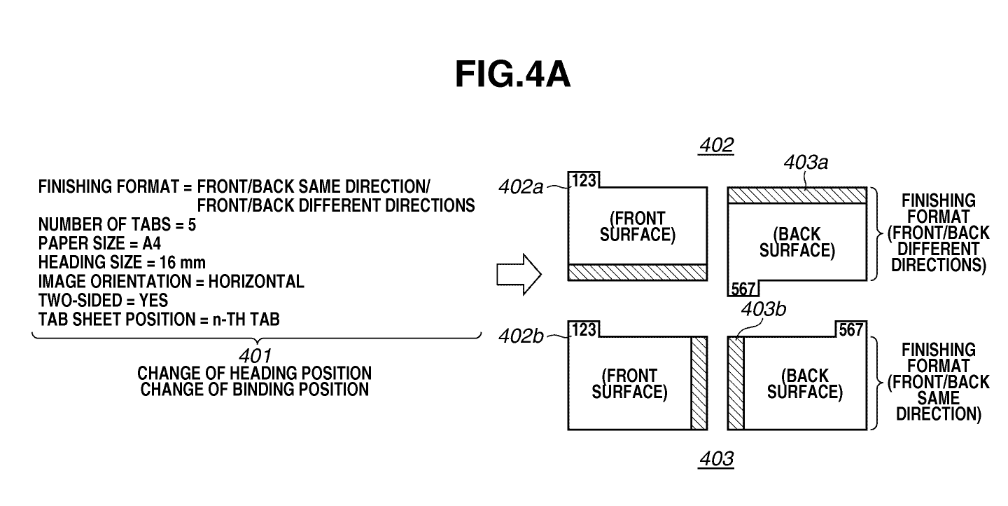

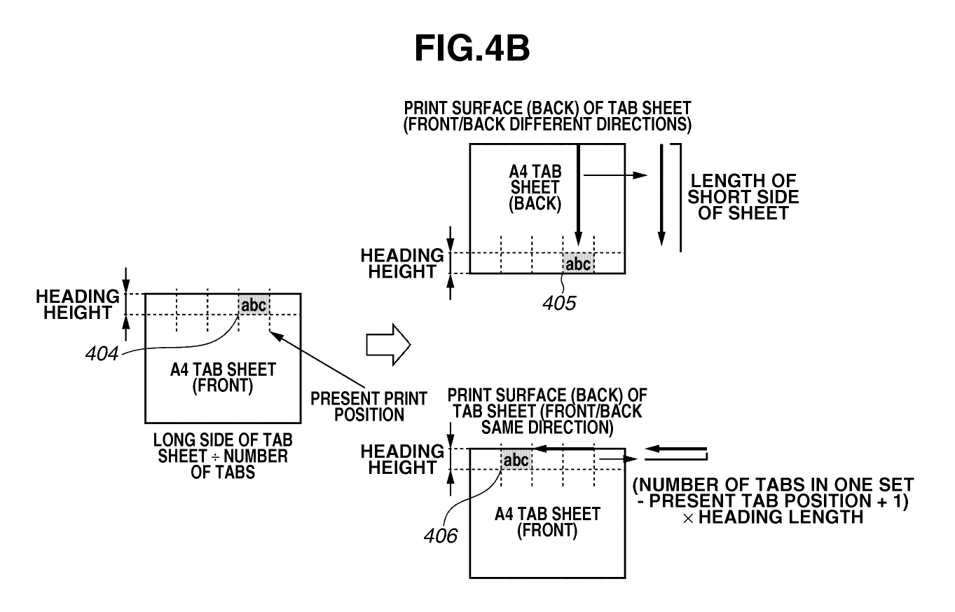

FIGS. 4A and 4B illustrate tab sheet document generation processing that can be applied to the image forming apparatus according to the present exemplary embodiment. FIG. 4A illustrates tab sheet generation setting values 401 and tab sheet heading output examples that can be output according to the setting values 401.

For example, the main body control unit 202 of the image forming apparatus acquires print setting information from a print job received from the end user environment 101 and reads tab sheet generation setting values 401 required to generate a tab sheet document.

In the present exemplary embodiment, the tab sheet generation setting values 401 include image orientation of a document, tab sheet number-of-headings setting (see 302), insertion paper size setting (see 304), tab sheet heading height setting (see 305), finishing format setting (see 306), and print surface setting (see 307), which can be set by users via the setting screen illustrated in FIG. 3.

The main body control unit 202 acquires the tab sheet generation setting values 401 and positional information of a tab sheet to be subjected to printing, and identifies the drawing position of the heading 402 (i.e., headings 402a and 402b). Regarding the drawing position of the heading 402, the main body control unit 202 changes the print position according to a setting value in the finishing format setting field 306 set by a user using the setting screen illustrated in FIG. 3.

Therefore, the main body control unit 202 adjusts each binding position 403 (i.e., binding positions 403a and 403b) in such a way as to locate a heading area where heading characters (e.g., [abc] in the present exemplary embodiment) are positioned similarly in both the front and back surfaces when the heading characters are printed on the tab sheet. In FIG. 4A, each binding position is indicated by oblique lines.

FIG. 4B illustrates an example calculation of the drawing position of a tab sheet heading image that can be realized by the main body control unit 202. To determine the drawing position of the heading 402, the main body control unit 202 adjusts the print position according to the setting value in the finishing format setting field 306.

Hereinafter, an example adjustment of the drawing position for heading information to be printed on the back surface of the tab sheet according to the finishing format based on the tab position on the front surface of the tab sheet illustrated in FIG. 4B is described.

For example, if the setting value in the finishing format setting field 306 is “different directions” with respect to the front/back surfaces, the main body control unit 202 sets a heading reference position 405 for the back surface document of the tab sheet in such a way as to coincide with a position shifted (offset) toward the outer side of the sheet (i.e., the lower side in FIG. 4B) from a heading reference position 404 for the front surface document of the tab sheet. The shift (offset) amount in this case is equal to the length of a short side of the sheet.

In the present exemplary embodiment, the finishing format “different directions” with respect to the front/back surfaces indicates that tab sheets are generated according to the calendar format. Accordingly, when an image is printed on each of the front/back surfaces of a tab sheet using a two-sided printing function of the image forming unit 210, if a front surface tab portion is positioned at the heading reference position 404, a tab position in the back surface printing becomes the heading reference position 405 (i.e., a position shifted (offset) by an amount comparable to the length of a short side of the sheet).

Further, if the setting value in the finishing format setting field 306 is “same direction” with respect to the front/back surfaces, the main body control unit 202 sets a heading reference position 406 for the back surface document of the tab sheet in such a way as to coincide with a position shifted (offset) toward the left side of the sheet from the heading reference position 404 for the front surface document of the tab sheet. The shift (offset) amount in this case is equal to (the number of tabs in one set−present tab position+1)×heading length. Thus, the drawing position of the heading moves in the horizontal direction by the above-described amount.

Then, with reference to the drawing shift amount calculated using the above-described formula, the main body control unit 202 performs printing of the same heading information on both sides of the tab sheet at respective tab positions. In this case, the heading information (e.g., heading characters) can be aligned along the front edge direction in the printed state.

Thus, when a tab sheet is printed based on the above-described control and stored upright in a drawer, heading characters printed on a tab portion coincide with each other in position on both sides of the tab sheet and users can easily recognize heading characters on the printed tab sheet.

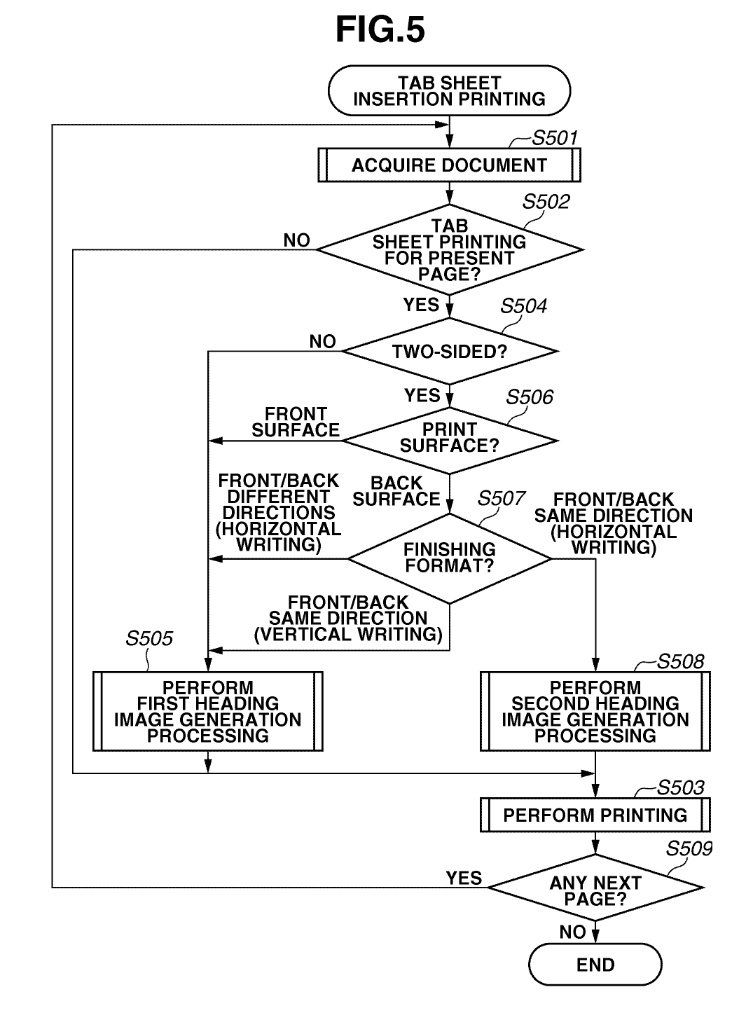

FIG. 5 is a flowchart illustrating a control procedure for controlling the image forming apparatus according to the present exemplary embodiment. The image forming apparatus performs the processing described in FIG. 5 when the image forming apparatus has received a print job from the end user environment 101. To realize the processing of respective steps relating to first tab sheet heading print control, a central processing unit (CPU) (not illustrated) constituting the main body control unit 202 executes a control program loaded into a random access memory (RAM) from a read only memory (ROM) or another nonvolatile memory.

As described in detail below, the main body control unit 202 receives a print job from the end user environment 101, and determines a layout of heading information in such a way as to align the information similarly in the up and down direction on front/back surfaces of a tab portion of each tab sheet using sheet print information included in the received job.

Further, as described in detail below, the main body control unit 202 performs two-sided printing on front/back surfaces of a tab position of a conveyed tab sheet using the determined layout of the heading information.

In the present exemplary embodiment and other exemplary embodiments, tab sheet print information includes the number of tabs in one set, sheet type of each tab sheet, paper size of each tab sheet, heading height of each tab sheet, finishing format of each tab sheet, and two-sided printing of each tab sheet.

In step S501, if the image forming apparatus 106 receives a print job from the end user environment 101, the image forming apparatus 106 sends the print job to the main body control unit 202. The main body control unit 202 reads page and print settings from the print job.

Next, in step S502, the main body control unit 202 determines whether a presently processed page requires tab sheet printing. If the main body control unit 202 determines that the presently processed page does not require any tab sheet printing (NO in step S502), then in step S503, the main body control unit 202 controls the image forming unit 210 to perform printing using general paper (i.e., a sheet other than the tab sheet) in order of pages of the original document as illustrated in FIG. 7.

On the other hand, if the main body control unit 202 determines that the presently processed page requires tab sheet printing (YES in step S502), then in step S504, the main body control unit 202 determined whether the one-sided/two-sided print setting state for the tab sheet in the print job is “two-sided printing.”

If the main body control unit 202 determines that the one-sided/two-sided print setting state is “one-sided printing” (NO in step S504), then in step S505, the main body control unit 202 performs first heading image generation processing as described below.

On the other hand, if the main body control unit 202 determines that the one-sided/two-sided print setting state is “two-sided printing” (YES in step S504), then in step S506, the main body control unit 202 determines whether the print surface of the present page is the front side or the other side of a tab sheet. If the main body control unit 202 determines that the print surface is the front side, then in step S505, the main body control unit 202 performs the first heading image generation processing in the same manner as processing for the one-sided printing.

On the other hand, if in step S506 the main body control unit 202 determines that the print surface is the other side, the processing proceeds to step S507. Then, in step S507, the main body control unit 202 acquires setting information in the finishing format setting field 306 and the image orientation. Then, with respect to the finishing format, the main body control unit 202 determines whether the image orientation is “horizontal writing” and “different directions” with respect to the front/back surfaces, or the image orientation is “vertical writing” and “same direction” with respect to the front/back surfaces, or the image orientation is “horizontal writing” and “same direction” with respect to the front/back surfaces.

If the main body control unit 202 determines that the image orientation in the finishing format setting field 306 is “horizontal writing” and “different directions” with respect to the front/back surfaces or the image orientation in the finishing format setting field 306 is “vertical writing” and “same direction” with respect to the front/back surfaces, the processing proceeds to step S505. Then, in step S505, the main body control unit 202 performs the first heading image generation processing, similar to the processing for the tab sheet one-sided printing.

On the other hand, if in step S507 the main body control unit 2020 determines that the image orientation in the finishing format setting field 306 is “horizontal writing” and “same direction” with respect to the front/back surfaces, then in step S508, the main body control unit 202 performs second heading image generation processing.

If the first heading image generation processing or the second heading image generation processing has been completed, then in step S503, the main body control unit 202 controls the image forming unit 210 to print each generated tab sheet image. If the printing of the generated tab sheet image is completed, then in step S509, the main body control unit 202 checks the presence of the next page. If the main body control unit 202 determines that the next page is present (YES in step S509), the processing returns to step S501 and the main body control unit 202 repeats the above-described processing. On the other hand, if the main body control unit 202 determines that there is not any page to be processed (NO in step S509), the main body control unit 202 terminates the processing of the flowchart illustrated in FIG. 5.

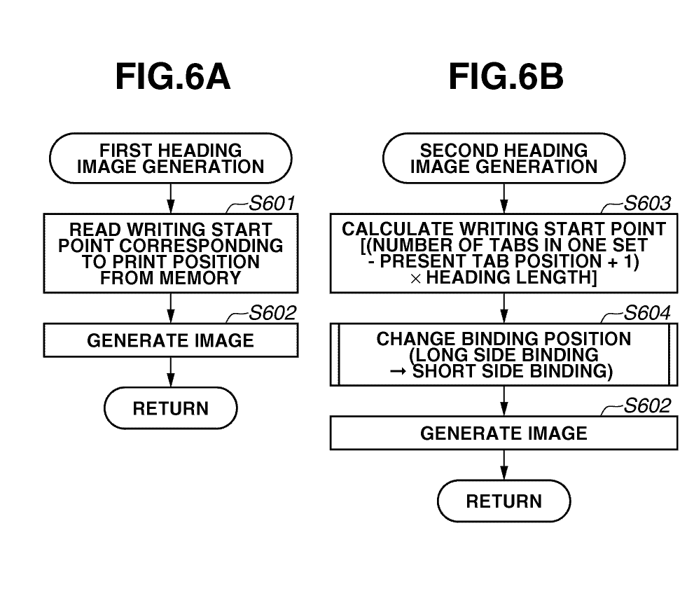

FIGS. 6A and 6B are flowcharts illustrating example control procedures for controlling the image forming apparatus according to the present exemplary embodiment. The processing procedures illustrated in FIGS. 6A and 6B can be executed when the image forming apparatus receives a print job from the end user environment 101. To realize the processing of respective steps illustrated in FIGS. 6A and 6B, the CPU (not illustrated) constituting the main body control unit 202 executes a control program loaded into the RAM from the ROM or another nonvolatile memory.

FIG. 6A illustrates a detailed procedure of the processing to be performed in step S505 (the first heading image generation processing) illustrated in FIG. 5. FIG. 6B illustrates a detailed procedure of the processing to be performed in step S508 (i.e., the second heading image generation processing) illustrated in FIG. 5. Hereinafter, example heading information layout processing that can be realized by the main body control unit 202 is described in detail below.

In the first heading image generation processing illustrated in FIG. 6A (i.e., the processing to be performed in step S505 illustrated in FIG. 5), first in step S601, the main body control unit 202 identifies the position of the presently printing page with respect to the number of tabs in one set and reads a writing start reference point corresponding to the identified position from the memory. Then, in step S602, the main body control unit 202 generates an image with reference to the writing start reference point read from the memory and terminates the processing of the flowchart illustrated in FIG. 6A.

In the second heading image generation processing illustrated in FIG. 6B (i.e., the processing to be performed in step S508 illustrated in FIG. 5), first in step S603, the main body control unit 202 identifies the position of the presently printing page with respect to the number of tabs in one set and adjusts the writing start reference point according to the finishing format.

Next, in step S604, the main body control unit 202 changes the binding position in such a way as to correctly locate the front and back surfaces of the tab sheet. Then, in step S602, the main body control unit 202 generates an image and terminates the processing of the flowchart illustrated in FIG. 6B.

Thus, an output result that corresponds to the original document illustrated in FIG. 7 can be obtained. The present exemplary embodiment relates to an example of processing for a print job that includes a setting of a tab sheet to be inserted between the second page and the third page of the original document.

In the above-described exemplary embodiment, an output print job does not include any tab sheet document as part of the original document. Thus, even when the tab position of the front surface differs from the tab position of the back surface in the two-sided printing of a tab sheet, the printing system according to the present exemplary embodiment can print heading characters similarly on the front and back surfaces of a specified tab of the tab sheet.

In particular, in a case where the tab sheet print surfaces are “same direction” with respect to the front/back surfaces, the printing system according to the present exemplary embodiment can obtain a print result of heading characters aligned similarly along the front edge of each of the front and back surfaces when the heading characters are printed on a tab of the tab sheet (see FIG. 4B).

As described above, the first exemplary embodiment includes processing for generating a tab sheet image and performing printing of a heading on a tab sheet. A second exemplary embodiment includes the following processing. In the second exemplary embodiment, the end user environment 101 generates a print job that includes at least one tab sheet image as part of an original document. The image forming apparatus processes a print job when the job is received from the end user environment 101.

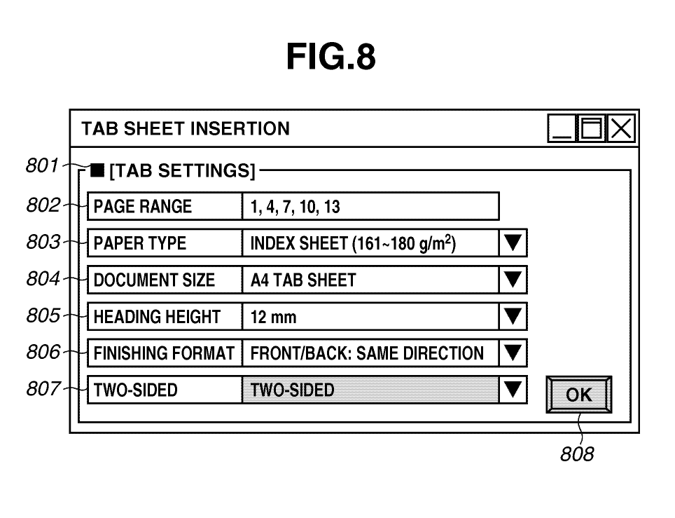

FIG. 8 illustrates an example of the user interface that can be displayed by a display apparatus included in the end user environment 101 illustrated in FIG. 1. Hereinafter, an example tab sheet print setting that can be performed in the end user environment 101 is described below with reference to FIG. 8. The setting screen illustrated in FIG. 8 is a tab sheet setting screen, which can be displayed to enable a user to set parameters for a tab sheet to be added to an original document.

In the present exemplary embodiment, the page number of the original document is usable to designate the insertion position of each tab sheet. According to the example settings illustrated in FIG. 8, a set of five tab sheets is added to the original document at a plurality of positions (i.e., first page, fourth page, seventh page, tenth page, and thirteenth page).

In FIG. 8, a setting screen 801 includes a setting field 802 in which insertion positions of a tab sheet to be used can be designated, a setting field 803 in which the type of an insertion paper can be designated, and a setting field 804 in which the size of the insertion paper can be designated. The setting screen 801 further includes a setting field 805 in which the heading height of the tab sheet can be designated, a setting field 806 in which the finishing format can be designated, and a setting field 807 in which the surface to be printed can be designated. The setting screen 801 further includes a setting fixing button 808.

In the present exemplary embodiment, the insertion paper type setting field 803, the insertion paper size setting field 804, the tab sheet heading height setting field 805, and the finishing format setting field 806 can be used for detailed settings of tab sheets to be printed.

In the end user environment 104 or the end user environment 105, if the setting fixing button (OK button) 808 is pressed, print setting information having been designated in respective items of the setting screen 801 illustrated in FIG. 8 can be converted into print data and transmitted to the image forming apparatus 106.

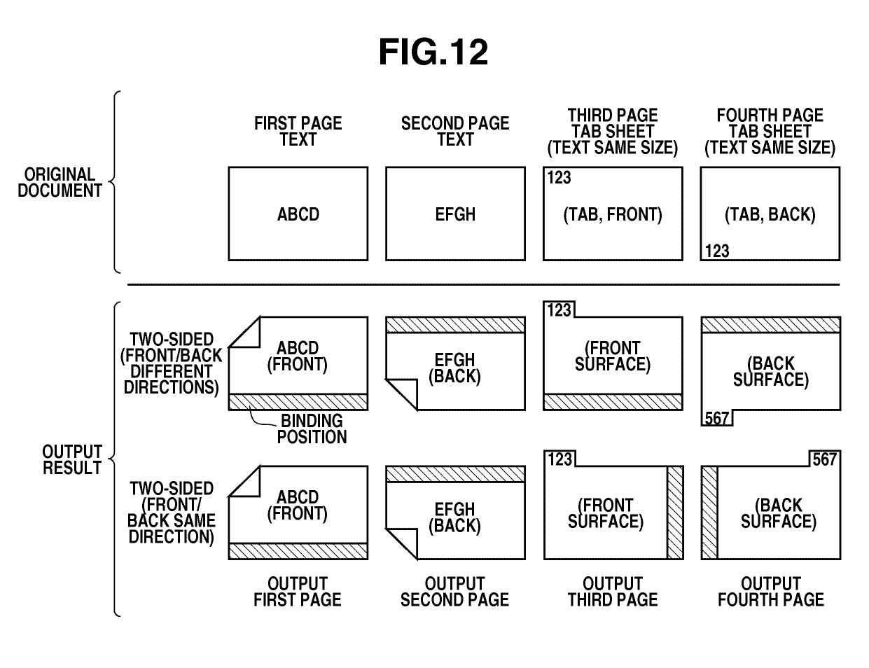

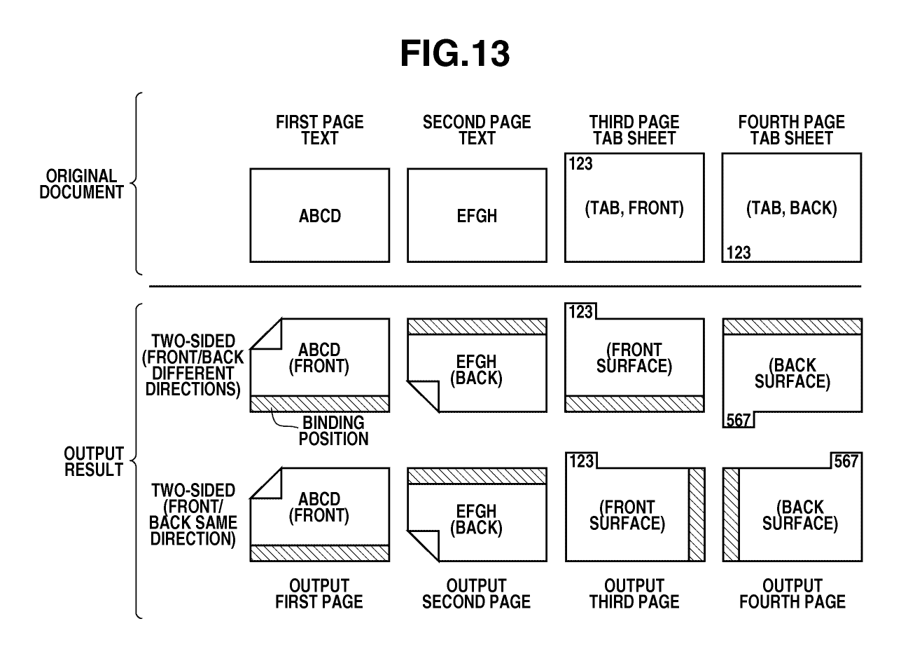

In the present exemplary embodiment, the print job includes print data that corresponds to tab sheet images illustrated in FIG. 12 or FIG. 13. Each tab sheet image included in the original document may be comparable to the text in size (see FIG. 12) or may be greater than the text (see FIG. 13).

Further, in the present exemplary embodiment, the original document is an example document including tab sheet images generated beforehand for the two-sided printing. However, according to the examples illustrated in FIG. 12 and FIG. 13, the heading positions of respective tab documents are designated to be “different directions” with respect to the front/back surfaces. Therefore, if it is required to print heading information in such a way as to be aligned in the same direction in both the front and back surfaces of the tab, processing for shifting the drawing position is required as described below.

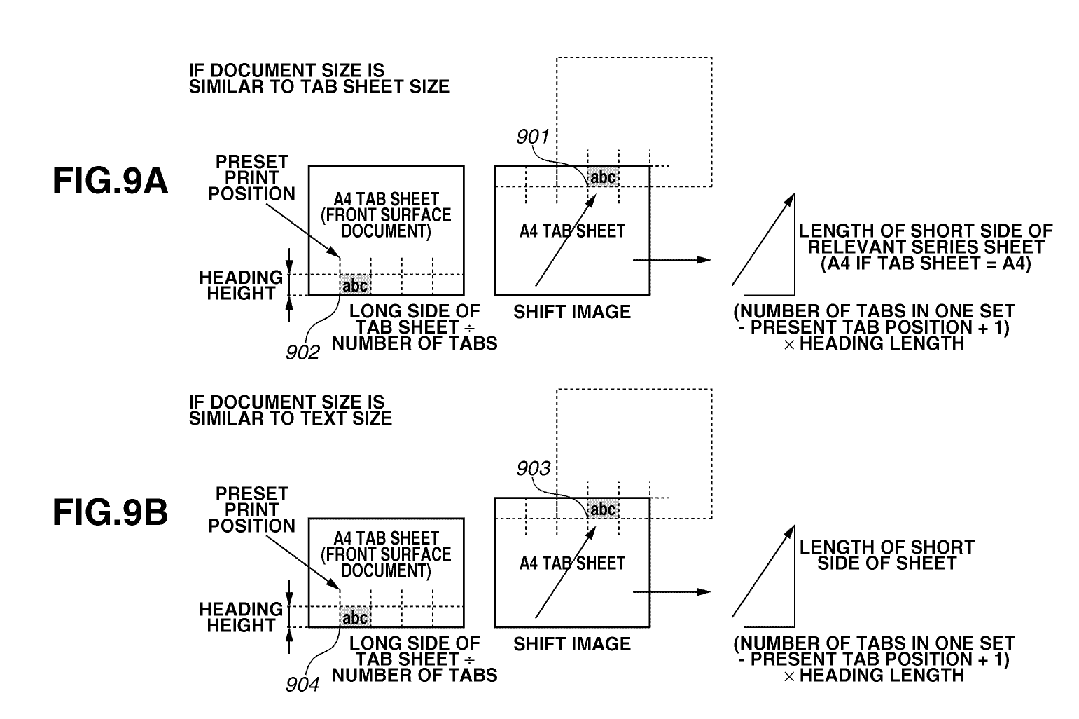

FIGS. 9A and 9B illustrate example calculations for obtaining the drawing position of the tab sheet heading image according to the present exemplary embodiment.

FIG. 9A illustrates an example calculation for calculating the drawing position of the tab sheet heading image in a case where a tab sheet generation document is similar to the tab sheet in size as illustrated in FIG. 12.

The drawing position of the heading 402 requires the print position to be changed according to the setting value in the finishing format setting field 806. If the setting value in the finishing format setting field 806 is “different directions” with respect to the front/back surfaces, the image forming apparatus performs printing according to the document without any change.

If the setting value in the finishing format setting field 806 is “same direction” with respect to the front/back surfaces, the main body control unit 202 sets a heading reference position 901 for the back surface document of the tab sheet in such a way as to coincide with a position shifted from a heading reference position 902 for the front surface document of the tab sheet.

In this case, the shift amount in the vertical direction is comparable to the length of a short side of the series sheet (e.g., A4 sheet for A4 tab sheet). The shift amount in the horizontal direction is comparable to (the number of tabs in one set−present tab position+1)×heading length, as indicated by the arrow in FIG. 9A.

FIG. 9B illustrates an example calculation for calculating the drawing position of the tab sheet heading image in a case where a tab sheet generation document is similar to the text in size as illustrated in FIG. 13. More specifically, the tab sheet is greater than the tab sheet generation document by an amount comparable to a tab that protrudes toward the front edge.

In FIG. 9B, the main body control unit 202 adjusts the print position for the drawing position of the heading 402 according to the finishing format setting value (see the setting field 806) having been set in the print job. For example, if the setting value in the finishing format setting field 806 is “different directions” with respect to the front/back surfaces, the image forming apparatus performs printing according to the document without any change.

Further, if the setting value in the finishing format setting field 806 is “same direction” with respect to the front/back surfaces, the main body control unit 202 sets a heading reference position 903 for the back surface document of the tab sheet in such a way as to coincide with a position shifted from a heading reference position 904 for the front surface document of the tab sheet. In this case, the shift amount in the vertical direction is comparable to the length of a short side of the sheet. The shift amount in the horizontal direction is comparable to (the number of tabs in one set−present tab position+1)×heading length, as indicated by the arrow in FIG. 9B.

More specifically, in the back surface printing, the image forming apparatus prints heading characters on a tab using a back surface tab sheet document, as illustrated in FIG. 12 or FIG. 13. Therefore, it is required to shift the drawing position as described above.

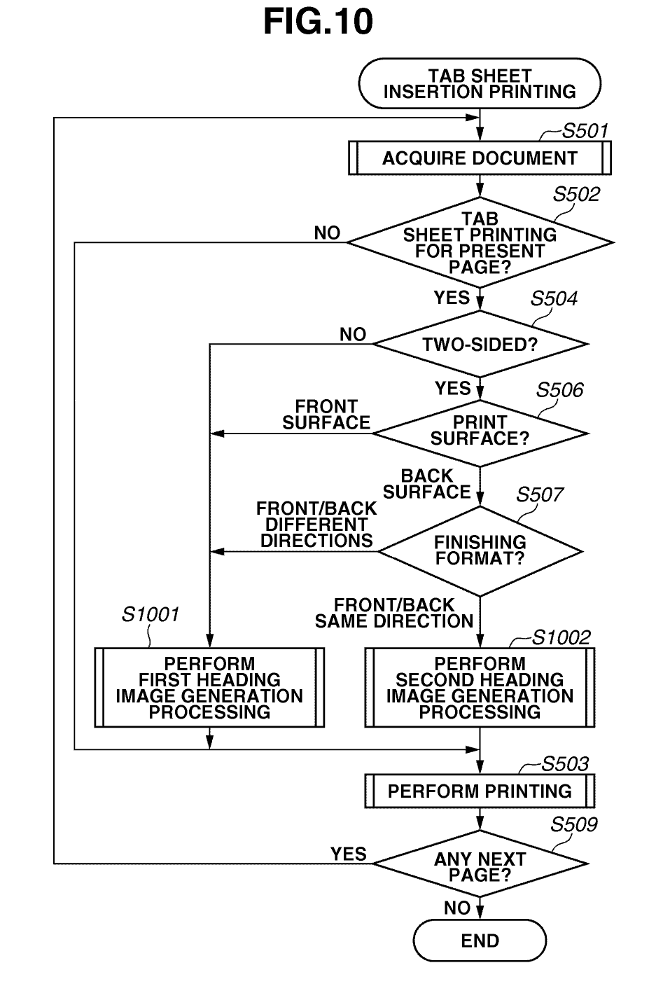

FIG. 10 is a flowchart illustrating an example control procedure for controlling the image forming apparatus according to the present exemplary embodiment. The processing procedure illustrated in FIG. 10 can be executed when the image forming apparatus receives a print job from the end user environment 101. To realize the processing of respective steps illustrated in FIG. 10, the CPU (not illustrated) constituting the main body control unit 202 executes a control program loaded into the RAM from the ROM or another nonvolatile memory.

As described below, the main body control unit 202 performs processing for receiving a print job including tab sheet print information from the end user environment 101 and determining the layout of heading information in such a way as to align the heading information similarly in the up and down direction on front/back surfaces of each tab of the tab sheet.

More specifically, if the image forming apparatus 106 receives a print job, then in step S501, the image forming apparatus 106 sends the received job to the main body control unit 202. The main body control unit 202 reads a page and related print settings from the job. In the present exemplary embodiment, the original document includes a tab generation document (including front and back surfaces).

Next, in step S502, the main body control unit 202 determines whether a presently processed page requires tab sheet printing. If the main body control unit 202 determines that the presently processed page does not require any tab sheet printing (NO in step S502), then in step S503, the main body control unit 202 performs printing using general paper (i.e., a sheet other than the tab sheet).

On the other hand, if the main body control unit 202 determines that the presently processed page requires tab sheet printing (YES in step S502), the processing proceeds to step S504. In step S504, the main body control unit 202 determines whether the print job includes any setting relating to one-sided/two-sided printing for the tab sheet.

If the main body control unit 202 determines that the one-sided/two-sided print setting state of the job is one-sided printing (NO in step S504), then in step S1001, the main body control unit 202 performs the first heading image generation processing. On the other hand, if the main body control unit 202 determines that the one-sided/two-sided print setting state of the job is two-sided printing (YES in step S504), the processing proceeds to step S506.

Then, in step S506, the main body control unit 202 determines whether the print surface of the present page is the front side of the tab sheet or the other side of the tab sheet. If the main body control unit 202 determines that the print surface is the front surface, then in step S1001, the main body control unit 202 performs the first heading image generation processing in the same manner as the processing for the one-sided printing.

On the other hand, if in step S506 the main body control unit 202 determines that the print surface is the back surface, the processing proceeds to step S507. Then, in step S507, the main body control unit 202 acquires the finishing format information (see the setting field 806) and image orientation from the print job and determines a finishing format based on the acquired information.

If in step S507 the main body control unit 202 determines that the finishing format (see the setting field 806) is “different directions” with respect to the front/back surfaces, then in step S1001, the main body control unit 202 performs the first heading image generation processing in the same manner as the processing for the one-sided printing.

On the other hand, in step S507, if the main body control unit 202 determines that the finishing format (see the setting field 806) is “same direction” with respect to the front/back surfaces, then in step S1002, the main body control unit 202 performs the second heading image generation processing.

Then, if the first heading image generation processing or the second heading image generation processing has been completed, then in step S503, the main body control unit 202 controls the image forming unit 210 to print a generated image. If the printing processing has been completed, then in step S509, the main body control unit 202 checks the presence of the next page.

If the next page is present (YES in step S509), the processing returns to step S501 and the main body control unit 202 repeats the above-described processing. On the other hand, if the main body control unit 202 determines that there is not any page to be processed (NO in step S509), the main body control unit 202 terminates the processing of the flowchart illustrated in FIG. 10.

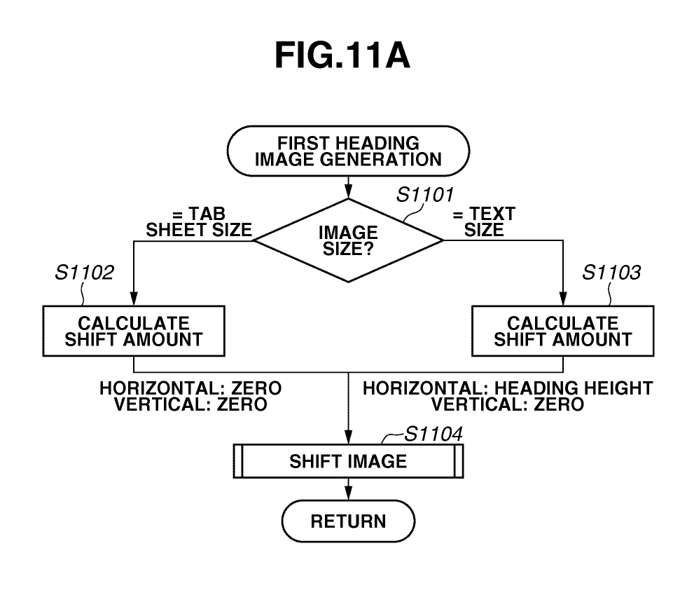

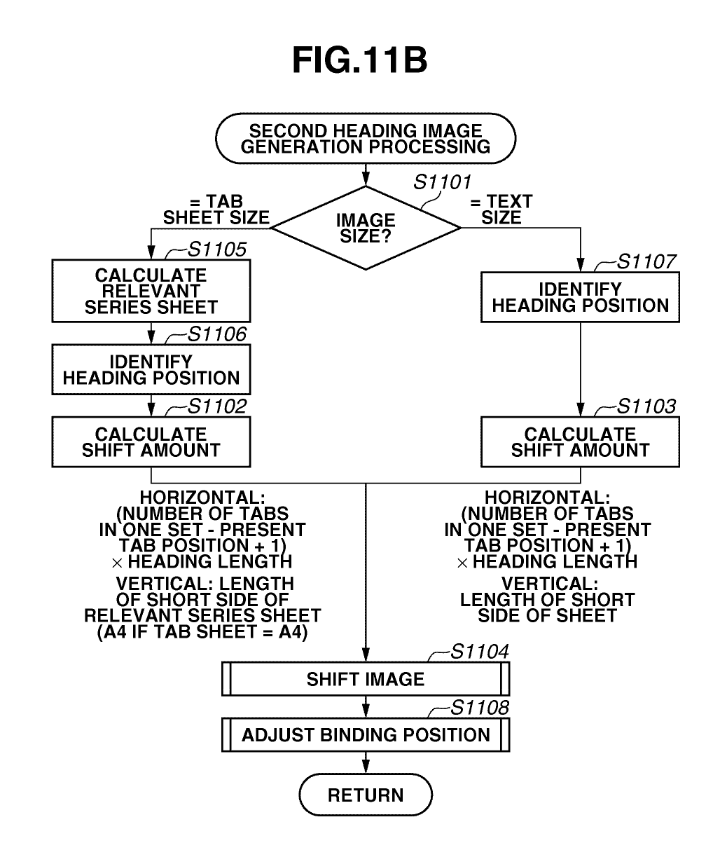

FIGS. 11A and 11B are flowcharts illustrating example control procedures for controlling the image forming apparatus according to the present exemplary embodiment. The processing procedures illustrated in FIGS. 11A and 11B can be executed when the image forming apparatus receives a print job from the end user environment 101. To realize the processing of respective steps illustrated in FIGS. 11A and 11B, the CPU (not illustrated) constituting the main body control unit 202 executes a control program loaded into the RAM from the ROM or another nonvolatile memory.

FIG. 11A illustrates a detailed procedure of the processing to be performed in step S1001 (i.e., the first heading image generation processing) illustrated in FIG. 10. FIG. 11B illustrates a detailed procedure of the processing to be performed in step S1002 (i.e., the second heading image generation processing) illustrated in FIG. 10. Hereinafter, example heading information layout processing that can be realized by the main body control unit 202 is described in detail below.

In the first heading image generation processing (i.e., the processing to be performed in step S1001), first in step S1101, the main body control unit 202 acquires the document size of a tab sheet to be printed, which has been set in the print job via the insertion paper size setting field 804.

If the main body control unit 202 determines that the insertion paper size (see the setting field 804) is similar to the tab sheet size, then in step S1102, the main body control unit 202 sets the image shift amount to be zero because the printing is performed without shifting tab sheet image.

On the other hand, if the main body control unit 202 determines that the insertion paper size (see the setting field 804) is similar to the text size, then in step S1103, the main body control unit 202 sets the image shift amount to be equal to a setting value in the heading height setting field 805 because the tab sheet image is required to move toward the outer side so as to fit for the tab sheet.

Then, in step S1104, the main body control unit 202 shifts the tab sheet image toward the outer side of the sheet by the setting amount calculated in step S1102 or step S1103. Then, the main body control unit 202 terminates the processing of the flowchart illustrated in FIG. 11A.

On the other hand, in the second heading image generation processing (i.e., the processing to be performed in step S1002), first in step S1101, the main body control unit 202 acquires the document size of a tab sheet to be printed, which has been set in the print job via the insertion paper size setting field 804.

If the main body control unit 202 determines that the insertion paper size (see the setting field 804) is similar to the tab sheet size, then in step S1105, the main body control unit 202 designates a series sheet of the tab sheet to be used to calculate the vertical position of the heading. For example, the main body control unit 202 designates A4 size if the size of the used tab sheet is A4 and Letter size if the size of the used tab sheet is Letter.

Then, in step S1106, the main body control unit 202 calculates a horizontal position of the heading to be printed on the back surface using the reference point on the front surface of the tab sheet. Then, in step S1102, the main body control unit 202 determines a shift amount required to print heading information in printing of the back surface of the tab sheet based on the horizontal position of the heading obtained in step S1105 and step S1106. Then, the main body control unit 202 terminates the processing of the flowchart illustrated in FIG. 11B.

On the other hand, if in step S1101 the main body control unit 202 determines that the insertion paper size (see the setting field 804) is similar to the text size, then in step S1107, the main body control unit 202 calculates a horizontal position of the heading to be printed on the back surface of the tab sheet using the reference point on the front surface of the tab sheet.

Next, in step S1103, the main body control unit 202 determines a shift amount required to determine the print position of the heading on the tab sheet in printing of the back surface of the tab sheet, based on the horizontal position of the heading to be printed on the back surface of the tab sheet calculated in step S1107 and the insertion paper size setting value (see the setting field 804) having been set in the print job.

Then, in step S1104, the main body control unit 202 shifts an image of the back surface of the tab sheet document toward the outer side of the sheet by the shift amount calculated in step S1102 or step S1103.

Then, in step S1108, the main body control unit 202 adjusts the binding position in imposition of the tab sheet for the positioning of the front and back surfaces of the tab sheet. Then, the main body control unit 202 terminates the processing of the flowchart illustrated in FIG. 11B.

Thus, if the tab sheet document generated by a user is similar to the text in size, the image forming apparatus can output a print result illustrated in FIG. 12. Further, if the tab sheet document generated by a user is similar to the tab sheet in size, the image forming apparatus can output a print result illustrated in FIG. 13.

Each of FIG. 12 and FIG. 13 illustrates an original document in comparison with an output result of printed tab sheets. In the present exemplary embodiment, if an original document includes any tab sheet document, the image forming apparatus can print heading information on front/back surfaces of a tab sheet based on the tab sheet document.

In particular, in a case where tab sheet print surfaces are “same direction” with respect to the front/back surfaces, the printing system according to the present exemplary embodiment can obtain a print result of heading characters aligned similarly along the front edge of each of the front and back surfaces when the heading characters are printed on a tab of the tab sheet.

Further, the printing system according to the present exemplary embodiment can print heading information on a tab without causing any positional deviation when a user generates a tab sheet document having a size comparable to the text and further when a user generates a tab sheet document having a size comparable to the tab sheet.

As described above, the second exemplary embodiment includes the processing of a print job that includes a tab sheet image dedicated to a front surface and a tab sheet image dedicated to a back surface as part of an original document beforehand.

Hereinafter, example processing according to a third exemplary embodiment is described below. In the third exemplary embodiment, the image forming apparatus processes a print job that includes only a front surface tab sheet document as part of an original document.

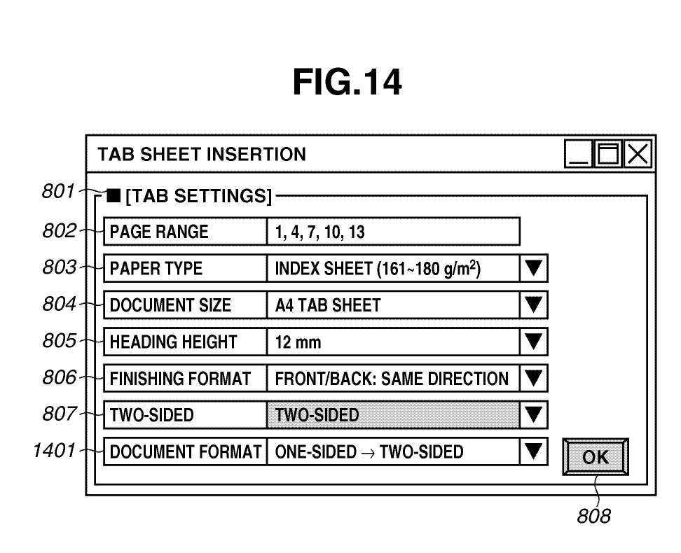

FIG. 14 illustrates an example of the user interface that can be displayed on the display apparatus included in the end user environment illustrated in FIG. 1. Hereinafter, an example tab sheet print setting in the end user environment 101 is described below with reference to FIG. 14. The user interface according to the present exemplary embodiment includes a document format setting field 1401, in which the document format can be designated, in addition the setting fields illustrated in the setting screen illustrated in FIG. 8.

More specifically, the setting screen 801 illustrated in FIG. 14 includes the insertion position setting field 802, the insertion paper type setting field 803, the insertion paper size setting field 804, the tab sheet heading height setting field 805, the finishing format setting field 806, the print surface setting field 807, the tab sheet document format setting field 1401, and the setting fixing button 808.

Users can press the setting fixing button (i.e., OK button) 808 after completing detailed settings for a tab sheet to be used in printing while designating setting values in the insertion paper type setting field 803, the insertion paper size setting field 804, the tab sheet heading height setting field 805, and the finishing format setting field 806.

If a user presses the setting fixing button 808, the end user environment 104 or the end user environment 105 converts the setting values in respective items of the setting screen 801 into print data and transmits a print job including the converted print data, as print setting information, to the image forming apparatus 106.

An example of tab sheet heading image drawing position calculation that can be realized by the main body control unit 202 according to the present exemplary embodiment is described below.

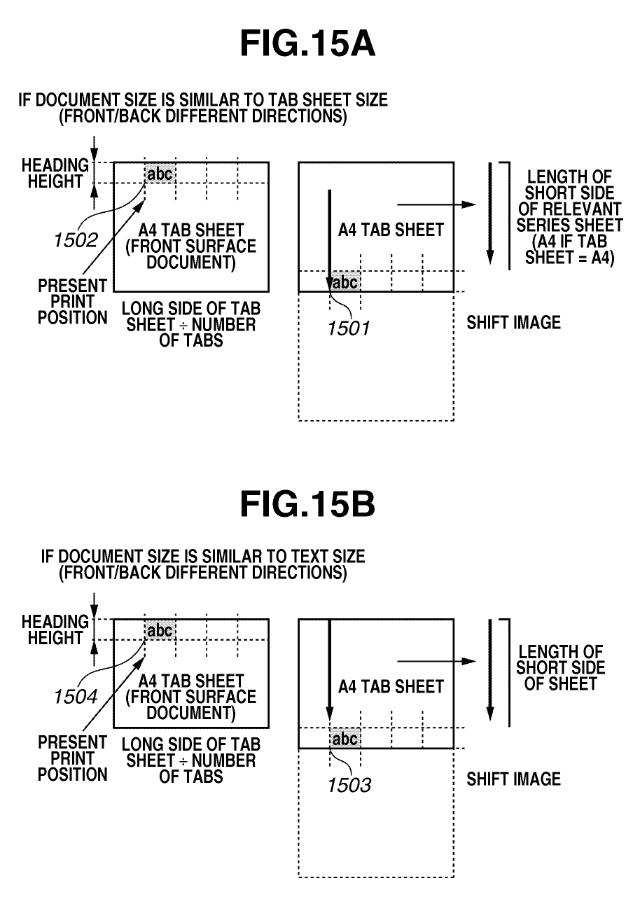

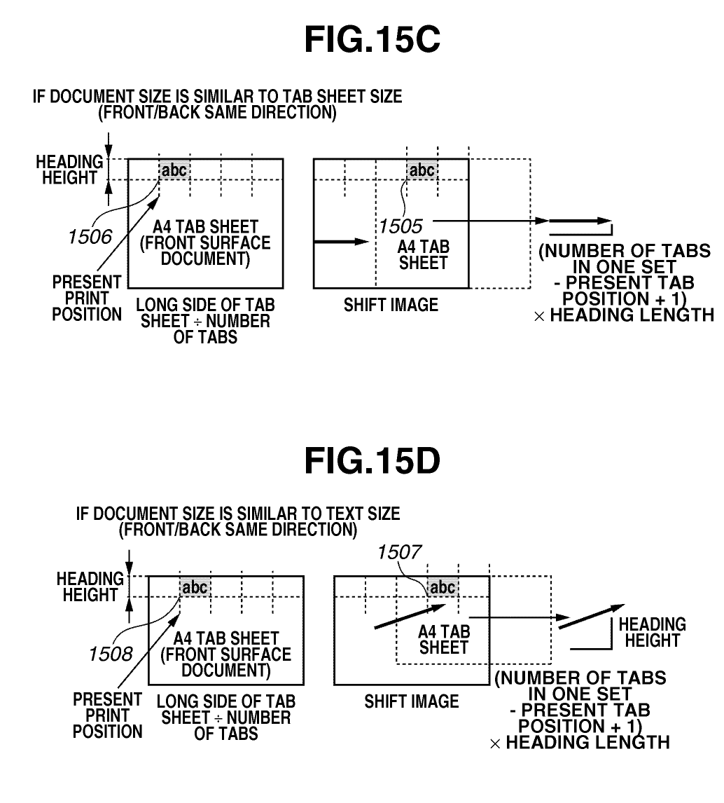

FIGS. 15A, 15B, 15C, and 15D illustrate the tab sheet heading image drawing position calculation that can be realized by the image forming apparatus according to the present exemplary embodiment. FIGS. 15A and 15C illustrate the tab sheet heading image drawing position calculation in a case where the tab sheet document is similar to the tab sheet in size.

In FIG. 15A, the main body control unit 202 adjusts the print position with respect to the drawing position of the heading 402 according to the finishing format setting value (see 806) having been set in the print job. For example, if the setting value in the finishing format setting field 806 is “different directions” with respect to the front/back surfaces, the main body control unit 202 sets a heading reference position 1501 on the back surface of the tab sheet in such a way as to coincide with a position shifted from a heading reference position 1502 on the front surface of the tab sheet.

In the present exemplary embodiment, only the front surface tab sheet document is included in the print job. Therefore, the main body control unit 202 calculates the shift amount in the following manner to determine the drawing position.

If a user generates a tab sheet document having a size comparable to that of the tab sheet, the main body control unit 202 calculates a shift amount that is equivalent to the length of a short side of the series sheet (e.g., A4 sheet for A4 tab sheet) in the vertical direction of the front surface tab sheet document.

On the other hand, regarding the shift amount in a case where the front surface tab sheet document is similar to the text in size, the main body control unit 202 adjusts the print position with respect to the drawing position of the heading 402 based on the setting value in the finishing format setting field 806 as illustrated in FIG. 15B.

More specifically, if the setting value in the finishing format setting field 806 illustrated in FIG. 14 is “different directions” with respect to the front/back surfaces, the main body control unit 202 sets a heading reference position 1503 for the back surface document of the tab sheet in such a way as to coincide with a position shifted from a heading reference position 1504 for the front surface document of the tab sheet in the vertical direction by an amount comparable to the length of a short side of the tab sheet.

On the other hand, if the document size is similar to the tab sheet size, the main body control unit 202 calculates the drawing position of a tab sheet heading image in the following manner.

As illustrated in FIG. 15C, the main body control unit 202 adjusts the drawing position of the heading 402 based on the setting value in the finishing format setting field 806 illustrated in FIG. 14. If the setting value in the finishing format setting field 806 illustrated in FIG. 14 is “same direction” with respect to the front/back surfaces, the main body control unit 202 sets a heading reference position 1505 for the back surface document of the tab sheet in such a way as to coincide with a position shifted from a heading reference position 1506 for the front surface document of the tab sheet, which is included in the original document as illustrated in FIG. 15C. In this case, the shift amount in the horizontal direction is comparable to (the number of tabs in one set−present tab position+1)×heading length.

If the tab sheet document is similar to the text in size as illustrated in FIG. 15D, the main body control unit 202 calculates the drawing position of a tab sheet heading image in the following manner.

In FIG. 15D, the main body control unit 202 adjusts the print position with respect to the drawing position of the heading 402 according to the setting value in the finishing format setting field 806 illustrated in FIG. 14. For example, if the setting value in the finishing format setting field 806 illustrated in FIG. 14 is “same direction” with respect to the front/back surfaces, the main body control unit 202 sets a heading reference position 1507 for the back surface document of the tab sheet in such a way as to coincide with a position shifted from a heading reference position 1508 for the front surface document of the tab sheet. In this case, the shift amount in the horizontal direction is comparable to (the number of tabs in one set−present tab position+1)×heading length. The shift amount in the vertical direction is comparable to the heading height.

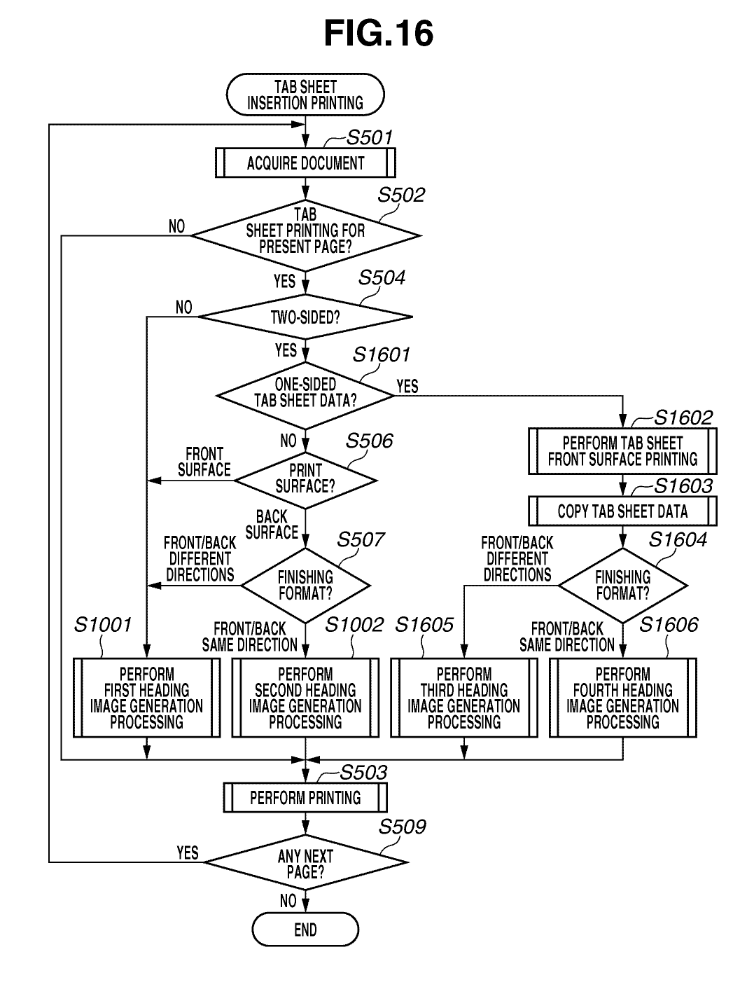

FIG. 16 is a flowchart illustrating an example control procedure for controlling the image forming apparatus according to the present exemplary embodiment. The processing procedure illustrated in FIG. 16 can be executed when the image forming apparatus receives a print job from the end user environment 101. To realize the processing of respective steps illustrated in FIG. 16, the CPU (not illustrated) constituting the main body control unit 202 executes a control program loaded into the RAM from the ROM or another nonvolatile memory.

As described below, the main body control unit 202 performs processing for receiving a print job including tab sheet print information from the end user environment 101 and determining the layout of heading information in such a way as to align the heading information similarly in the up and down direction on front/back surfaces of each tab of the tab sheet.

More specifically, if the image forming apparatus 106 receives a print job, then in step S501, the image forming apparatus 106 sends the received job to the main body control unit 202. The main body control unit 202 reads print settings from the job.

Next, in step S502, the main body control unit 202 determines whether a presently processed page requires tab sheet printing. If the main body control unit 202 determines that the presently processed page does not require any tab sheet printing (NO in step S502), then in step S503, the main body control unit 202 controls the image forming unit 210 to perform printing using general paper (i.e., a sheet other than the tab sheet).

On the other hand, if the main body control unit 202 determines that the presently processed page requires tab sheet printing (YES in step S502), the processing proceeds to step S504. In step S504, the main body control unit 202 determines whether the print job includes any setting relating to one-sided/two-sided printing for the tab sheet.

If the main body control unit 202 determines that the one-sided/two-sided print setting state of the job is one-sided printing (NO in step S504), then in step S1001, the main body control unit 202 performs the first heading image generation processing.

On the other hand, if the main body control unit 202 determines that the one-sided/two-sided print setting state of the job is two-sided printing (YES in step S504), the processing proceeds to step S1601. Then, in step S1601, the main body control unit 202 determines whether the document format of the tab sheet is two-sided tab sheet data or one-sided tab sheet data with reference to the tab sheet document format setting value (see the setting field 1401) having been set in the print job.

More specifically, the main body control unit 202 determines whether two-sided tab sheet data or one-sided tab sheet data is included as a tab sheet document in the original document.

If the main body control unit 202 determines that the tab sheet document data is two-sided printing tab sheet data (NO in step S1601), then in step S506, the main body control unit 202 determines whether the print surface of the present page is the front side of the tab sheet or the other side of the tab sheet. If the main body control unit 202 determines that the print surface is the front surface, then in step S1001, the main body control unit 202 performs the first heading image generation processing in the same manner as the processing for the one-sided printing.

On the other hand, if in step S506 the main body control unit 202 determines that the print surface is the back surface, then in step S507, the main body control unit 202 determines whether the finishing format is “different directions” or “same direction” with respect to the front/back surfaces with reference to the setting value in the finishing format setting field 806.

If the main body control unit 202 determines that the setting value in the finishing format setting field 806 is “different directions” with respect to the front/back surfaces, then in step S1001, the main body control unit 202 performs the first heading image generation processing in the same manner as the processing for the one-sided printing.

On the other hand, if in step S507 the main body control unit 202 determines that the setting value in the finishing format setting field 806 is “same direction” with respect to the front/back surfaces, then in step S1002, the main body control unit 202 performs the second heading image generation processing.

Further, if the main body control unit 202 determines that the tab sheet document data is one-sided printing tab sheet data (YES in step S1601), the processing proceeds to step S1602.

Then, in step S1602, the main body control unit 202 controls the image forming unit 210 to perform printing of the front surface of the tab sheet. Next, in step S1603, the main body control unit 202 copies the tab sheet data used in the printing of the front surface in the memory. Then, in step S1604, the main body control unit 202 acquires the finishing format setting value (see the setting field 806) having been set in the print job and determines whether the finishing format is “different directions” or “same direction” with respect to the front/back surfaces.

If the main body control unit 202 determines that the setting value in the finishing format setting field 806 is “different directions” with respect to the front/back surfaces, then in step S1605, the main body control unit 202 performs third heading image generation processing in the same manner as the processing for the one-sided printing.

On the other hand, if in step S1604 the main body control unit 202 determines that the setting value in the finishing format setting field 806 is “same direction” with respect to the front/back surfaces, then in step S1606, the main body control unit 202 performs fourth heading image generation processing.

If the first to fourth heading image generation processing is completed, then in step S503, the main body control unit 202 controls the image forming unit 210 to print the generated tab sheet image on a tab sheet. Subsequently, in step S509, the main body control unit 202 checks the presence of the next page.

If the next page is present (YES in step S509), the processing returns to step S501 and the main body control unit 202 repeats the above-described processing. On the other hand, if the main body control unit 202 determines that there is not any page to be processed (NO in step S509), the main body control unit 202 terminates the processing of the flowchart illustrated in FIG. 16.

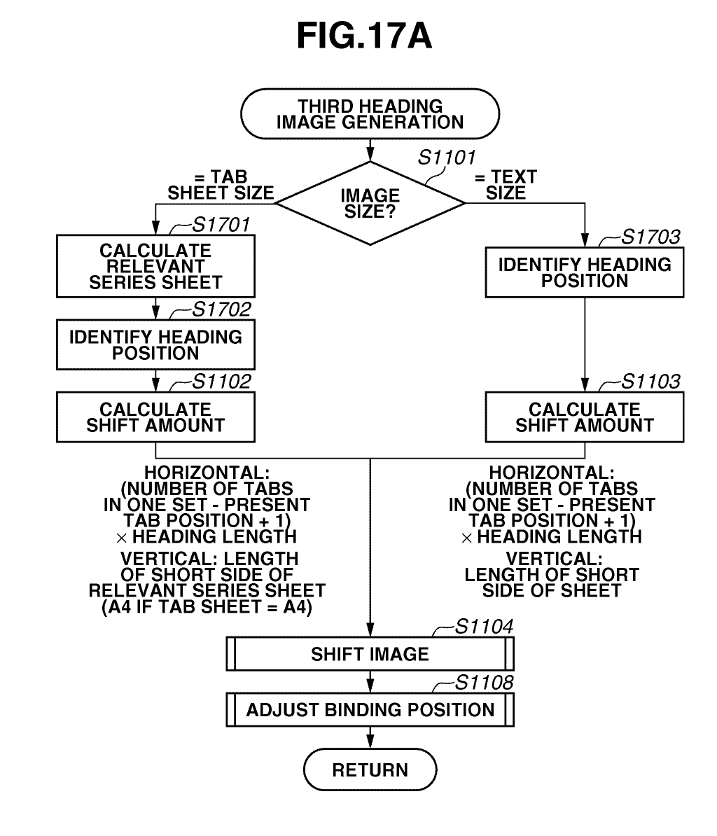

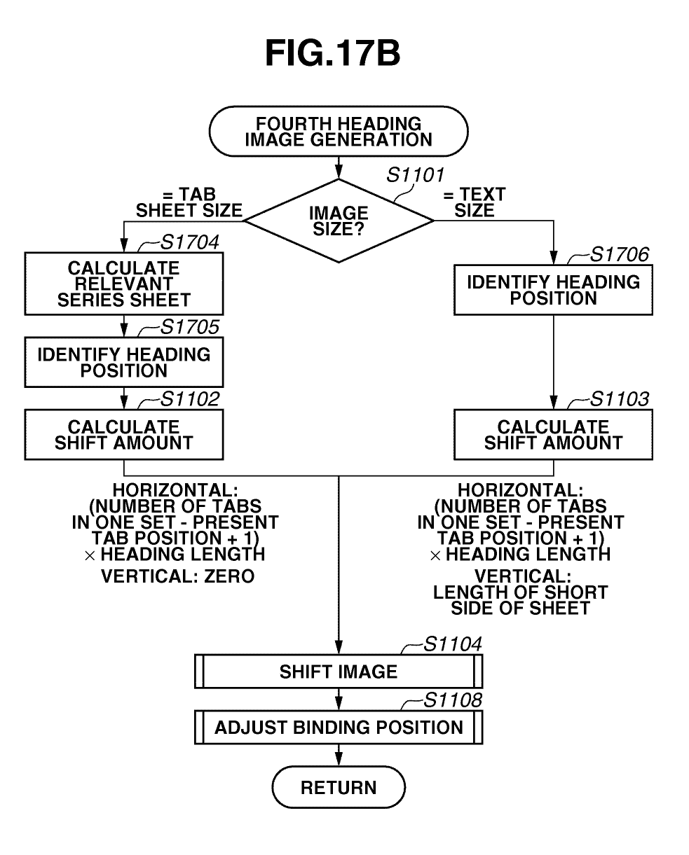

FIGS. 17A and 17B are flowcharts illustrating example control procedures for controlling the image forming apparatus according to the present exemplary embodiment. The processing procedures illustrated in FIGS. 17A and 17B can be executed when the image forming apparatus receives a print job from the end user environment 101. To realize the processing of respective steps illustrated in FIGS. 17A and 17B, the CPU (not illustrated) constituting the main body control unit 202 executes a control program loaded into the RAM from the ROM or another nonvolatile memory.

FIG. 17A illustrates a detailed procedure of the processing to be performed in the step S1605 (i.e., the third heading image generation processing) illustrated in FIG. 16. FIG. 17B illustrates a detailed procedure of the processing to be performed in the step S1606 (i.e., the fourth heading image generation processing) illustrated in FIG. 16. Hereinafter, example heading information layout processing that can be realized by the main body control unit 202 is described in detail below.

In the third heading image generation processing (i.e., the processing to be performed in step S1605), first in step S1101, the main body control unit 202 acquires the document size of a tab sheet to be printed, which has been set in the print job via the insertion paper size setting field 804 of the setting screen illustrated in FIG. 14.

If in step S1101 the main body control unit 202 determines that the insertion paper size (see the setting field 804) is similar to the tab sheet size, then in step S1701, the main body control unit 202 designates a series sheet of the tab sheet to be used to calculate the vertical position of the heading on the back tab sheet document. For example, the main body control unit 202 designates A4 size if the size of the used tab sheet is A4 and Letter size if the size of the used tab sheet is Letter.

Next, in step S1702, the main body control unit 202 calculates the horizontal position of the heading to be printed on the back surface using the reference point on the front surface of the printed tab sheet. Next, in step S1102, the main body control unit 202 determines a shift amount of a tab sheet image to perform back surface tab sheet printing, based on the horizontal position of the heading and the Letter size value obtained in step S1701 and step S1702.

If in step S1101 the main body control unit 202 determines that the insertion paper size (see the setting field 804) is similar to the text size, the processing proceeds to step S1703.

Then, in step S1703, the main body control unit 202 calculates a horizontal position of the heading to be printed on the back surface using the reference point on the front surface of the printed tab sheet. Next, in step S1103, the main body control unit 202 determines a shift amount based on the value obtained in step S1703 and the insertion paper size (see the setting field 804).

Next, in step S1104, the main body control unit 202 shifts the image toward the outer side of the sheet by the value calculated in step S1102 or step S1103. Then, in step S1108, the main body control unit 202 adjusts the binding position in imposition of the tab sheet for the positioning of the front and back surfaces of the tab sheet. Then, the main body control unit 202 terminates the processing of the flowchart illustrated in FIG. 17A.

On the other hand, in the fourth heading image generation processing (i.e., the processing to be performed in step S1606) illustrated in FIG. 17B, first in step S1101, the main body control unit 202 acquires the document size of a tab sheet to be printed, which has been set in the print job via the insertion paper size setting field 804.

If the main body control unit 202 determines that the insertion paper size (see the setting field 804) is similar to the tab sheet, then in step S1704, the main body control unit 202 designates a series sheet of the tab sheet to be used to calculate the vertical position of the heading. For example, the main body control unit 202 designates A4 size if the size of the used tab sheet is A4 and Letter size if the size of the used tab sheet is Letter.

Next, in step S1705, the main body control unit 202 calculates the horizontal position of the heading to be printed on the back surface using the reference point on the front surface of the printed tab sheet. Next, in step S1102, the main body control unit 202 determines a shift amount based on the horizontal position of the heading on the back surface of the tab sheet and the Letter size value obtained in step S1704 and step S1705.

On the other hand, if in step S1101 the main body control unit 202 determines that the insertion paper size (see the setting field 804) is similar to the text size, then in step S1706, the main body control unit 202 calculates a horizontal position of the heading to be printed on the back surface of the tab sheet using the reference point on the front surface of the printed tab sheet.

Next, in step S1103, the main body control unit 202 determines a shift amount based on the value obtained in step S1706 and the insertion paper size (see the setting field 804). Then, in step S1104, the main body control unit 202 shifts a front surface tab sheet image on the memory so that the back surface tab sheet printing can be performed by shifting the reference point of the front surface tab sheet toward the outer side to perform printing of the back surface of the tab sheet using the values obtained in steps S1102 and S1103.

Then, in step S1108, the main body control unit 202 adjusts the binding position in imposition of the tab sheet for the positioning of the front and back surfaces of the tab sheet. Then, the main body control unit 202 terminates the processing of the flowchart illustrated in FIG. 17B.

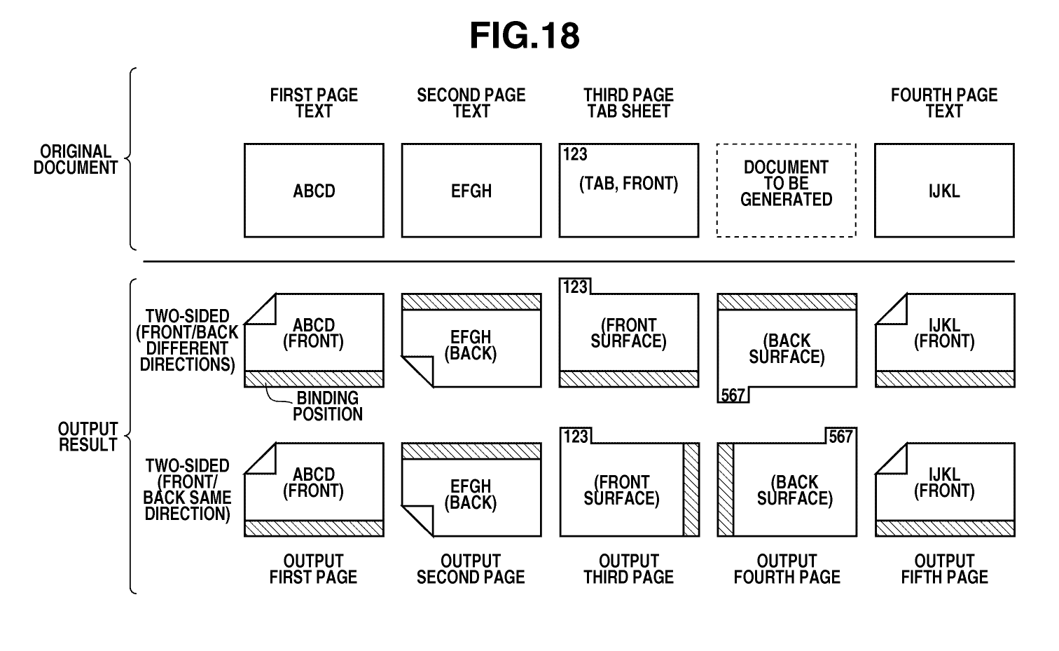

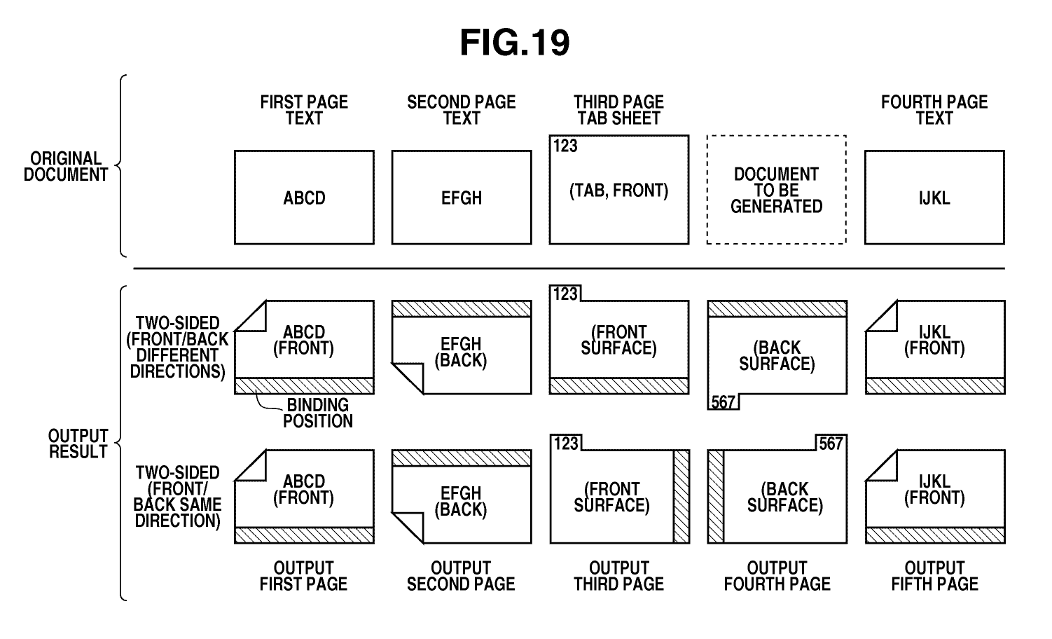

Each of FIG. 18 and FIG. 19 illustrates an original document in comparison with an output result of printed tab sheets. FIG. 18 illustrates a document output result including an inserted tab sheet, which can be obtained when a user generates a document having a size comparable to that of the text. Further, FIG. 19 illustrates a document output result including an inserted tab sheet, which can be obtained when a user generates a document having a size comparable to that of the tab sheet.

In the present exemplary embodiment, if only a front surface tab sheet document is included in an original document, the image forming apparatus can generate a back surface tab sheet document based on the front surface tab sheet document and can print heading information on front/back surfaces of a tab sheet based on the generated tab sheet document.

In particular, in a case where tab sheet print surfaces are “same direction” with respect to the front/back surfaces, the printing system according to the present exemplary embodiment can obtain a print result of heading characters aligned similarly along the front edge of each of the front and back surfaces when the heading characters are printed on a tab of the tab sheet.

Further, the printing system according to the present exemplary embodiment can print heading information on a tab without causing any positional deviation when a user generates a tab sheet document having a size comparable to the text and further when a user generates a tab sheet document having a size comparable to the tab sheet.

In the above-described exemplary embodiments, the image forming apparatus receives setting information that determines whether to equalize the orientation of an image to be printed on a tab portion of the front surface of a tab sheet with the orientation of an image to be printed on a tab portion of the back surface of the tab sheet.

However, the method for setting the orientation of an image to be printed on a tab portion of the tab sheet is not limited to the above-described method. For example, the printing system described in the first exemplary embodiment can be modified to enable users to independently set the orientation of an image to be printed on a tab portion of the front surface of a tab sheet and the orientation of an image to be printed on a tab portion of the back surface of the tab sheet.

In this case, via the screen illustrated in FIG. 3, users can determine whether to print the image on the tab portion of the front surface of the tab sheet along the direction indicated by 402a in FIG. 4A or print the image along the direction rotated by 180 degrees.

Further, via the screen illustrated in FIG. 3, users can determine whether to generate and print the image on the tab portion of the back surface of the tab sheet along the direction indicated by 402b in FIG. 4A or print the image along the direction after rotating the image by 180 degrees.

If the setting is performed using the above-described method, the control unit 202 generates a tab portion image according to the designated method and controls the image forming unit 210 to print the tab portion image. Thus, users can arbitrary set the orientation of an image to be printed on a tab portion of the front surface of a tab sheet and the orientation of an image to be printed on a tab portion of the back surface of the tab sheet. Each user can obtain a printed product that includes an image printed on a tab portion of a tab sheet according to a designated orientation.

Further, it is useful to print an image on a tab portion of the front surface of a tab sheet along the fixed direction indicated by 402a and enable each user to determine whether to print an image on a tab portion of the back surface of the tab sheet along the direction indicated by 402a or the direction indicated by 402b in FIG. 4A.

When the setting is performed using the above-described method, the control unit 202 generates an image to be printed on a tab portion of the front surface of a tab sheet to have the orientation indicated by 402a and prints the generated image. Further, the control unit 202 generates an image to be printed on a tab portion of the back surface of the tab sheet. In this case, if a user designates printing of a rotated image (e.g., by an amount of 180 degrees), the control unit 202 rotates the image 180 degrees and performs printing based on the rotated image.

In the above-described example settings, the orientation of each document image is horizontal as illustrated in FIGS. 4A and 4B. However, the above-described settings can be applied similarly even when the orientation of a document image is vertical. Further, as described in the second exemplary embodiment or in the third exemplary embodiment, if the end user environment 101 generates an image to be printed on a tab portion of a tab sheet beforehand, it is useful to rotate a tab portion image according to the orientation designated by a user.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In an example, a computer-readable medium may store a program that causes a printing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-279669 filed Dec. 15, 2010, which is hereby incorporated by reference herein in its entirety.

What is claimed is:

1. A printing apparatus to print an image on both surfaces of a tab sheet, the printing apparatus comprising:
a setting unit configured to set whether to align an orientation of a first image to be printed on a first surface tab portion of a first surface of the tab sheet with an orientation of a second image to be printed on a second surface tab portion of a second surface of the tab sheet; and
a printing unit configured to, in response to the setting unit setting to align the orientation of the first image with the orientation of the second image, print the first image on the first surface tab portion and the second image on the second surface tab portion in such a way as to equalize the orientation of the first image with the orientation of the second image, and configured to, in response to the setting unit setting not to align the orientation of the first image with the orientation of the second image, print the first image on the first surface tab portion and the second image on the second surface tab portion in such a way as to differentiate the orientation of the first image from the orientation of the second image.

2. The printing apparatus according to claim 1, further comprising:
an obtaining unit configured to obtain image data including tab image data of an image to be printed on the tab portion of the tab sheet; and
an image processing unit configured to shift the tab image data included in the image data obtained by the obtaining unit according to whether the setting unit sets to align the orientation of the first image with the orientation of the second image.

3. The printing apparatus according to claim 2, wherein the image processing unit is configured to differentiate a method for shifting the tab image data included in the image data obtained by the obtaining unit between (i) a case where it is set to align the orientation of the first image with the orientation of the second image and (ii) a case where it is set not to align the orientation of the first image with the orientation of the second image.

4. The printing apparatus according to claim 2, wherein the obtaining unit is configured to obtain, from an external apparatus, the image data including the tab image data of the image to be printed on the tab portion of the tab sheet.

5. A printing apparatus to print an image on both surfaces of a tab sheet, the printing apparatus comprising:
a receiving unit configured to receive, from a user, information indicating an orientation of a first image to be printed on a first surface tab portion of a first surface of the tab sheet and an orientation of a second image to be printed on a second surface tab portion of a second surface of the tab sheet; and
a printing unit configured to print the first image on the first surface tab portion and the second image on the second surface tab portion according to the information received by the receiving unit indicating the orientation of the first image and the orientation of the second image.

6. A method for controlling a printing apparatus to print an image on both surfaces of a tab sheet, the method comprising:
setting whether to align an orientation of a first image to be printed on a first surface tab portion of a first surface of the tab sheet with an orientation of a second image to be printed on a second surface tab portion of a second surface of the tab sheet;
printing, in response to setting to align the orientation of the first image with the orientation of the second image, the first image on the first surface tab portion and the second image on the second surface tab portion in such a way as to equalize the orientation of the first image with the orientation of the second image; and
printing, in response to setting not to align the orientation of the first image with the orientation of the second image, print the first image on the first surface tab portion and the second image on the second surface tab portion in such a way as to differentiate the orientation of the first image from the orientation of the second image.

7. A non-transitory computer-readable storage medium storing a computer program causing a printing apparatus to execute the method according to claim 6.
